(19) United States
(12) Patent Application Publication
(10) Pub. No.: US 2023/0129412 A1
(43) Pub. Date: Apr. 27, 2023

(54) DETECTION AND LOCALIZATION OF GAS EMISSION

(71) Applicant: Baker Hughes Holdings LLC, Houston, TX (US)

(72) Inventors: Arjun Roy, Katy, TX (US); Senthilkumar Datchanamoorthy, Bangalore (IN); Sangeeta Nundy, Denver, CO (US); Bhasker Rao Keely, Bangalore (IN); Godine Chan, Natick, MA (US); Okja Kim, Newton, MA (US); Rosa Swartwout, Tucson, AZ (US)

(21) Appl. No.: 17/964,454

(22) Filed: Oct. 12, 2022

Related U.S. Application Data
(60) Provisional application No. 63/270,928, filed on Oct. 22, 2021.

(51) Int. Cl. G01N 33/00

(52) U.S. Cl. CPC G01N 33/0075

(57) ABSTRACT

A method includes receiving data characterizing locations of potential sources and of potential sensors at an industrial site, and receiving data characterizing a plurality of wind velocities at the industrial site. The method includes calculating a first prediction error of localization associated with a first set of potential sensors of the plurality of potential sensors, calculating a second prediction error of localization associated with a second set of potential sensors of the plurality of potential sensors, the calculating being based on a second set of scenario prediction errors associated with the plurality of scenarios, and selecting the first set of potential sensors to provide locations associated the first sub-set of potential sensors.

### RELATED APPLICATION

This application claims priority under 35 U.S.C. § 119(e) to U.S. Provisional Patent Application No. 63/270,928 filed on Oct. 22, 2021, the entire content of which is hereby expressly incorporated by reference herein.

### BACKGROUND

Monitoring and detection of gas leaks is commonly performed by inspection of industrial assets, such as assets configured in gas production and distribution environment, mining and bio-gas industries, waste-water treatment plants, and other environments. Inspections can be performed to ensure operational safety of the assets and to determine the presence of leaks or gas emissions which can be emanating from an emission source. Gas leaks in these environments can create hazardous operating conditions for personnel assigned to operate, maintain, and repair the industrial assets and can reduce production rates. Gas leaks can occur as a result of equipment failures which can cause the release of unplanned, or fugitive gaseous emission. Gas leaks can also occur as a result of venting that is part of the normal and expected operation of the equipment or assets. Localized weather patterns can alter the concentration, location, and distribution of the gas emission making it difficult to accurately determine an emission source associated with the gas leak.

### SUMMARY

In one aspect, a method includes receiving data characterizing locations of a plurality of potential sources and locations of a plurality of potential sensors at an industrial site, and receiving data characterizing a plurality of wind velocities at the industrial site. The method also includes calculating a first prediction error of localization associated with a first set of potential sensors of the plurality of potential sensors. The calculating is based on a first set of scenario prediction errors associated with a plurality of scenarios. The method further includes calculating a second prediction error of localization associated with a second set of potential sensors of the plurality of potential sensors, the calculating based on a second set of scenario prediction errors associated with the plurality of scenarios. Each scenario of the plurality of scenarios includes a wind velocity of the plurality of wind velocities and a potential source of the plurality of potential sources. The method also includes selecting the first set of potential sensors, wherein the first prediction error is lower than the second prediction error; and providing locations associated the first sub-set of potential sensors.

One or more of the following features can be included in any feasible combination.

In some implementations, the method includes calculating the first set of scenario prediction errors. Each scenario prediction error of the first set of scenario prediction errors is associated with a unique scenario of the plurality of scenarios. The method also includes setting the first prediction error to a maximum value of the first set of scenario prediction errors. In some implementations, a first scenario prediction error of the first set of scenario prediction errors is associated with a first scenario of the plurality of scenarios. The first scenario includes a first source of the plurality of potential sources and a first wind velocity of the plurality of wind velocity.

In some implementations, the method further includes calculating the first scenario prediction error by at least calculating a location of the first source using an iterative method based on a predictive dispersion model configured to receive the first wind velocity and received location of the first source as input; and setting the first scenario prediction error as a difference between the calculated location and a received location of the first source. In some implementations, calculating the theoretical location is further based on a first leakage probability associated with the first source. In some implementations, each wind velocity of the plurality of wind velocities includes a wind speed and a probability of wind flow along a direction of the wind velocity. In some implementations, the method further includes receiving a map of the industrial site, wherein the map is indicative of the locations of the plurality of potential sources and the locations of the plurality of potential sensor.

In some implementations, a method includes receiving data characterizing locations of a plurality of potential sources and a plurality of potential sensors at an industrial site, and data characterizing a plurality of wind velocities at the industrial site. The method also includes selecting a first set of sensors from the plurality of potential sensors; and identifying a first number of scenarios of a plurality of scenarios where at least one sensor of the first set of potential sensors detects a gas leak above a threshold leakage value. The method further includes calculating a first detection probability associated with the first set of sensors based on the first number of scenarios and a total number of scenarios in the plurality of scenarios; and providing the detection probability associated with the first set of sensors.

In some implementations, each scenario of the plurality of scenarios includes a wind velocity of the plurality of wind velocities and a potential source of the plurality of potential sources. In some implementations, calculating the first detection probability includes calculating the sum of probability of each scenario in the first number of scenarios. The probability of a first scenario in the first number of scenarios is given by the product of the probability of the leakage source corresponding to the first scenario and the probability of the wind velocity of the first scenario.

In some implementations, the method further includes selecting a second set of sensors from the plurality of potential sensors; identifying a second number of scenarios of the plurality of scenarios where at least one sensor of the second set of potential sensors detects a gas leak above the threshold leakage value; calculating a second detection probability based on the second number of scenarios; and providing the second detection probability associated with the second set of sensors. In some implementations, the method further includes selecting the first set of sensors over the second set of sensors. The first detection probability is greater than the second detection probability, and the first set of sensors and the second set of sensors have the same number of sensors.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

### DESCRIPTION OF DRAWINGS

These and other features will be more readily understood from the following detailed description taken in conjunction with the accompanying drawings, in which:

FIG. 1 is a flowchart of an exemplary method of determination of sensor location for identification of location of leakage sources;

FIG. 2 illustrates an exemplary GUI display space for providing input data for sensor location determination for the method described in FIG. 1;

FIG. 3 illustrates an exemplary plot of historical wind velocities;

FIG. 4 illustrates a plot of the distribution of direction of wind flow described in FIG. 3

FIG. 5 illustrates an exemplary map of the industrial site that includes the location of possible sources and possible locations of the sensors;

FIG. 6 illustrates an exemplary emission concentration map associated with the various sources in FIG. 5;

FIG. 7 is a flowchart of an exemplary method of determination of sensor locations for detection of leakage at an industrial site;

FIG. 8 illustrates an exemplary plot of probability of leakage source location identification (orange curve) and the probability of leak detection (blue curve) versus number of sensors; and

FIG. 9 illustrates an exemplary graph of probability of detection versus the number of sensors for various leak rates at the industrial site.

### DETAILED DESCRIPTION

Industrial sites associated with production and distribution of gas (e.g., methane, carbon di-oxide, hydrogen, etc.) include industrial assets that generate/store gas and networks of pipelines that couple the industrial assets (e.g., by transporting/distributing the gas). The various industrial assets/pipelines can act as an emission source of the gas that may be released into the atmosphere. Operators of the industrial site can perform monitoring and inspection of the pipelines and industrial assets to detect leaks or emissions which may be released during failure of an industrial asset and may cause unsafe operating conditions or reduce operating production rates. Operators also perform monitoring and inspection of the pipelines and industrial assets to ensure that the venting of the gas is occurring in accordance with the expected and normal operational characteristics. Determining the presence of leakage and location of the source(s) of detection can be a time-consuming and an error prone process. The process can be further complicated by the presence of prevailing seasonal wind or weather conditions which may distribute the gas emission in a manner which can make determining the presence of leakage and challenging.

Determination of the presence of a gas leakage and location of the sources of the gas leakage can be improved based on the placement of sensors at the industrial site. This can be done, for example, by identifying the number of sensors and their corresponding locations at the industrial site. In some implementations of the current subject matter, a user (e.g., an operator) can provide potential locations of the sources and the sensors at the industrial site. For example, the user can provide a map of the industrial site that includes the locations of the industrial assets and the network of pipelines that can be possible sources of gas leakage. The map can also identify possible locations where sensors can (or cannot) be placed. Additionally, historical data associated with wind velocity (e.g., wind speed, wind direction, etc.) and leak rates of the sources can also be provided. Based on this information, the location of the sensors suitable for leak detection at the industrial site or identification of the location of leakage sources can be determined (e.g., based on the map of the industrial site, historical wind velocity data, etc.).

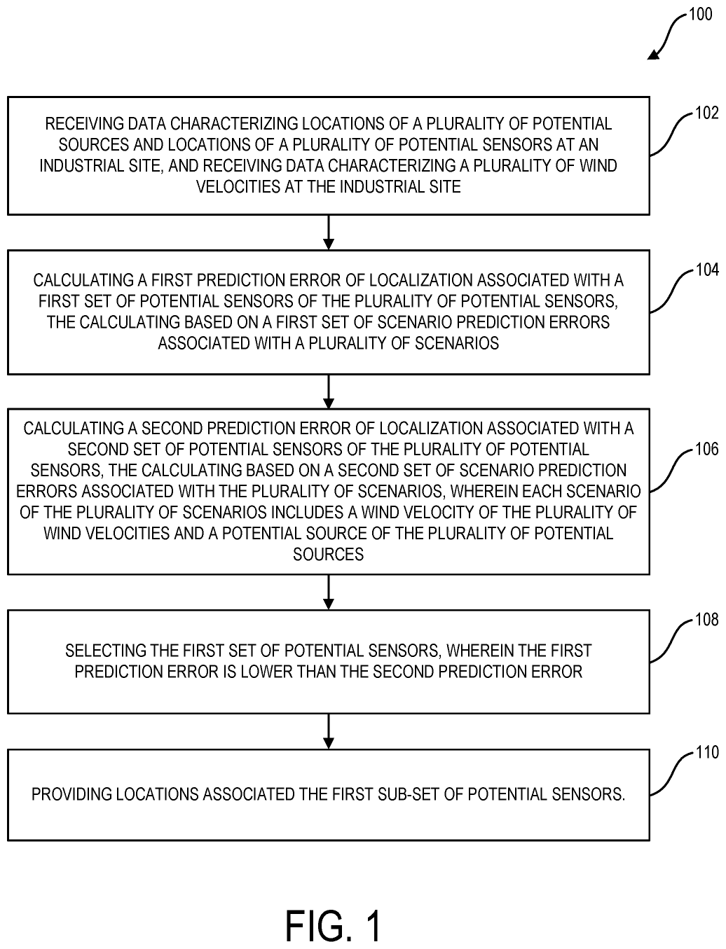

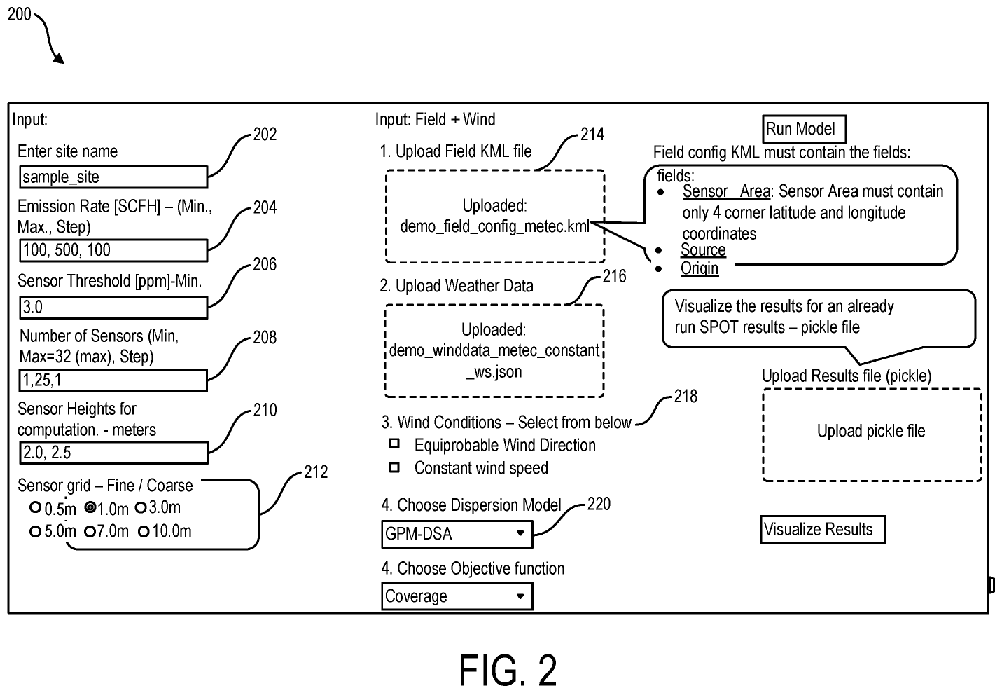

FIG. 1 is a flowchart of an exemplary method of determination of sensor location for identification of location of leakage sources (or localization of leakage sources). At step 102, data characterizing locations/leak rates of a plurality of potential sources (e.g., industrial assets, pipelines, etc.), locations of a plurality of potential sensors, and data characterizing a plurality of wind velocities (e.g., historical data on wind velocities) at an industrial site can be received (e.g., by one or more processors of a computing system associated with the industrial site). This information can be provided, for example, via a graphical user interface (GUI) display space by a user (or an operator). FIG. 2 illustrates an exemplary GUI display space 200 for providing input data for sensor location determination. A user or an operator can provide the name of the industrial site (at first input field 202), expected range of leak rate (at second input field 204), sensor threshold (e.g., in parts per million) (at third input field 206), the maximum number of allowed sensors (at fourth input field 208), and heights of the various sensors (at fifth input field 210). The operator can further request the desirable spatial accuracy of the method of determining sensor location. For example, via input grid 212, the user can provide the size of the square spatial grid (e.g., length of an edge of the grid) used in the simulation to determine sensor location. Information associated with the industrial site (e.g., map of the industrial site) that includes regions of the industrial site where the sensors can be placed (e.g., coordinates of the corners of the region), locations of industrial assets and pipes (which can act as possible leakage sources), etc., can be provided at the seventh input field 214. Weather data that can include historical wind velocity data (e.g., wind speed, wind direction, etc.) at the industrial site can be provided at eighth input field 216. The wind conditions used in the calculation of the location of the sensors can be provided at the ninth input field 218 and the predictive dispersion model can be selected in the tenth input field 220, respectively.

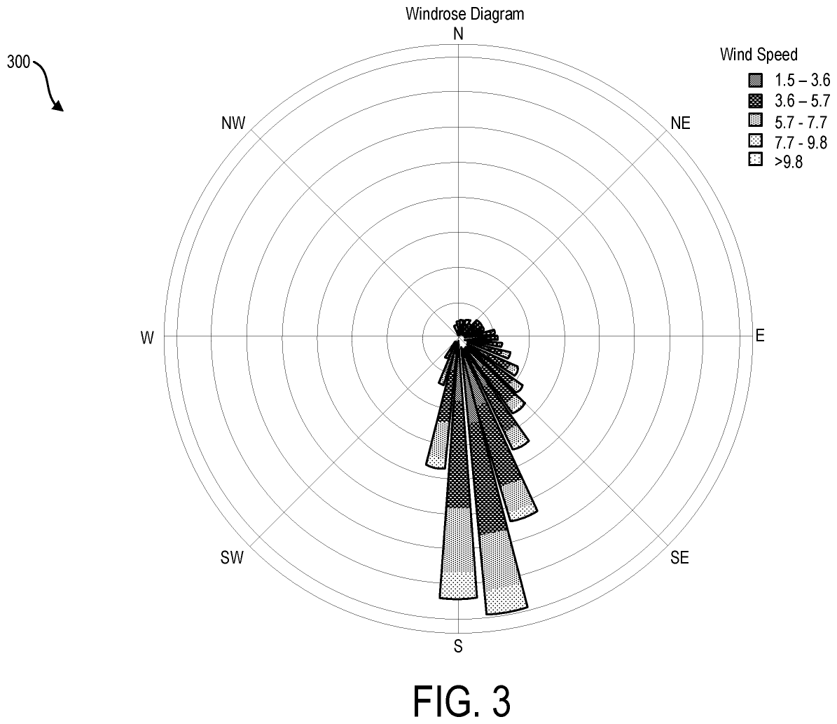

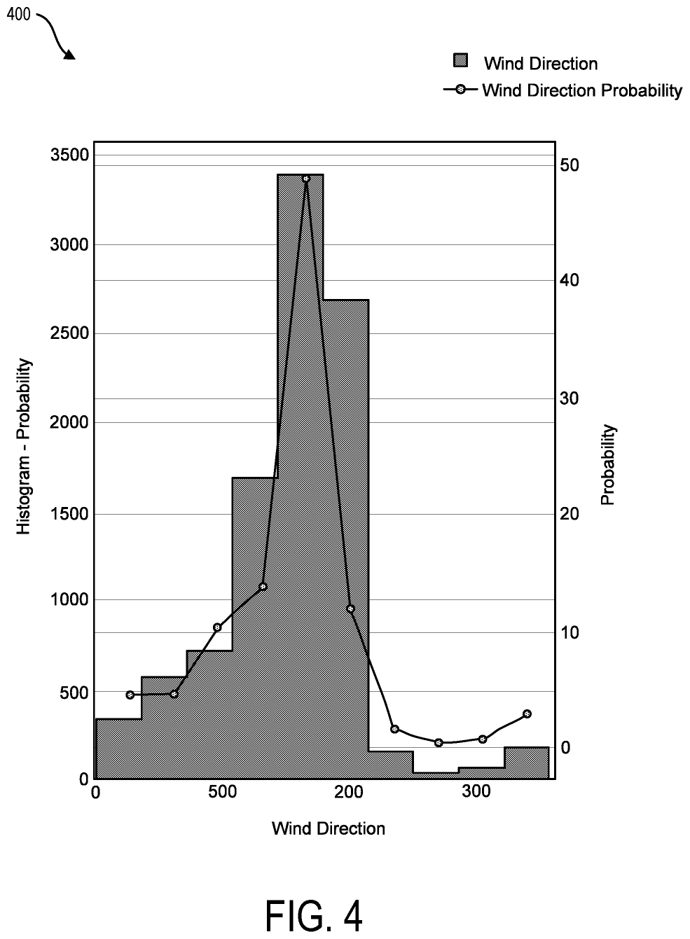

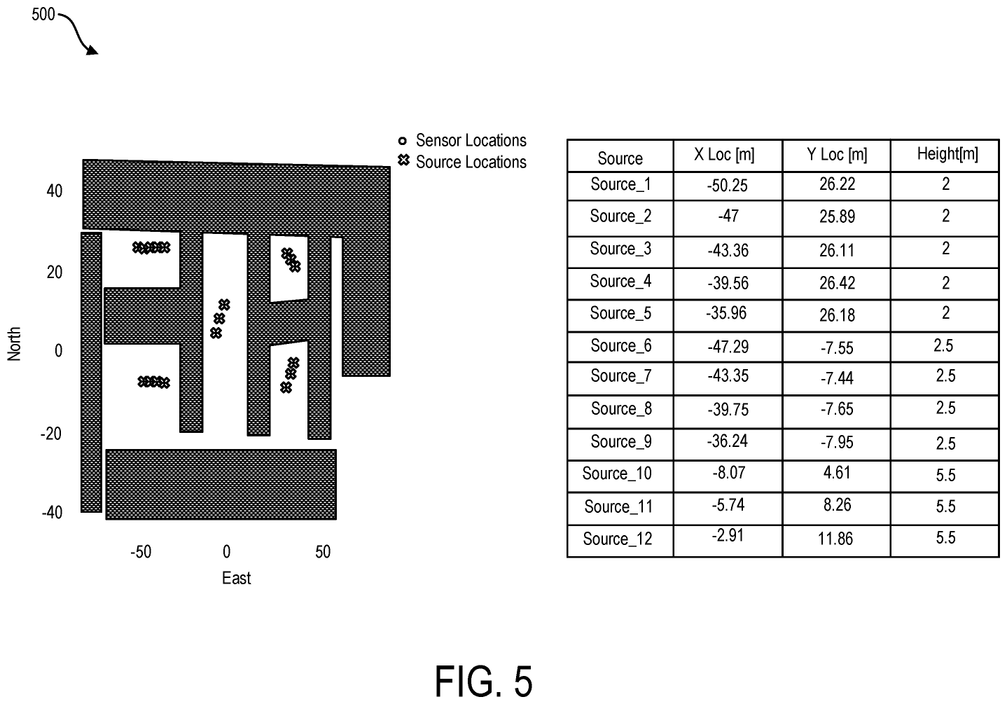

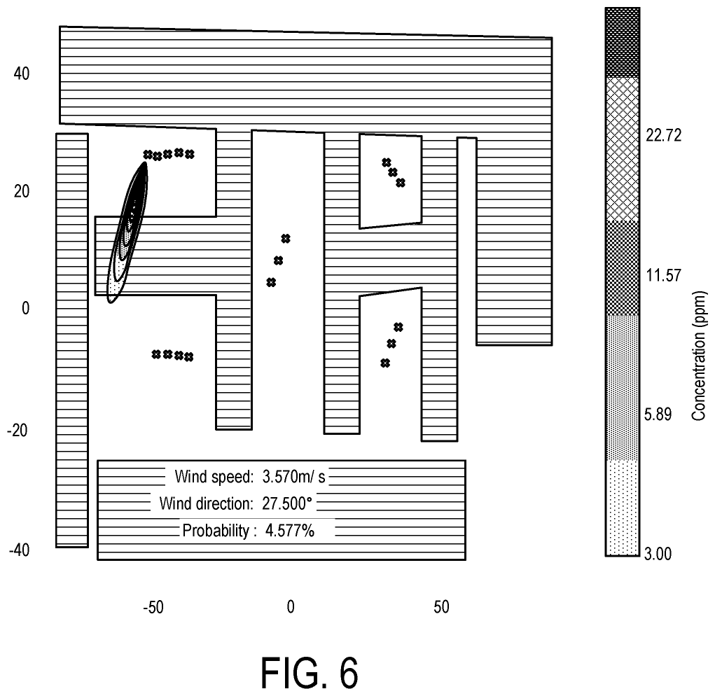

FIG. 3 illustrates an exemplary plot 300 of historical wind velocities. The orientation of a sector of the plot is indicative of the direction of the wind, the color of the sector is indicative of the wind speed and the length of the sector is indicative of the number of occurrences in the direction associated with the sector. FIG. 4 illustrates a plot 400 of the distribution of direction of wind flow described in FIG. 3. The x-axis is representative of the angle of wind flow (e.g., zero degrees indicative of due north and 180 degrees associated with due south) and the y-axis is representative of the number of occurrences. FIG. 5 illustrates an exemplary map 500 of the industrial site that includes the possible location of sources (indicated by red cross) and possible locations of the sensors (indicated by regions shaded in black). The table in FIG. 5 illustrates the location (e.g., x-coordinate, y-coordinate, etc.) and height of the source locations. FIG. 6 illustrates an exemplary emission concentration map 600 associated with the various sources in FIG. 5.

Returning back to FIG. 1, at step 104, a first prediction error of localization associated with a first set of potential sensors of the plurality of potential sensors can be calculated. In some implementations, multiple sets of potential locations of sensors (e.g., a first number of sensors) can be identified and a prediction error of localization can be calculated for each set. For example, a first set of potential locations of sensors can be selected from the potential sensor locations at the industrial site (e.g., the first set of locations can be selected from the regions shaded in black in the FIG. 5) and the first prediction error of localization can be calculated. In some implementations, first prediction error of localization can be calculated by defining a plurality of scenarios, calculating a scenario prediction error for each of the plurality of scenarios (e.g., for each unique scenario), and setting the first prediction error to a maximum value of the calculated scenario prediction errors.

A scenario can be defined as a combination (e.g., a tuple) of wind velocity and source (or source location). A scenario can be generated by selecting a source location and a wind velocity from the plurality of source location and the plurality of wind velocities, respectively, that are received at step 102. For example, from n source locations and m wind velocities, n x m scenarios can be generated. For a first scenario (e.g., which includes a first source and a first wind velocity) a scenario prediction error can be calculated. This can be done by calculating a location of the first source in the scenario using an iterative algorithm that includes a predictive dispersion model (e.g., the predictive dispersion model selected in input field 220).

The predictive dispersion model is configured to receive the wind velocity in the first scenario (e.g., first wind velocity), locations of the first set of sensors, the emission rate associated with the first source (e.g., received at second input field 204), and calculate a first location of the first source. In some implementations, the predictive dispersion model can also be used to calculate gas concentrations at the location of the sensors. In some implementations, in each iteration of the iterative algorithm, leakage rates of one or more sources in the identified areas can be calculated and compared with known values of gas concentration detected by the sensors. If the detected and calculated values are not within a predetermined threshold, the calculation by the predictive dispersion model is repeated (e.g., by varying the locations the sources in the predictive dispersion model). This process can be repeated until the detected and the calculated gas concentration values are within the predetermined threshold value. The details of the iterative algorithm based on the predictive dispersion model are described in Application No. 63/270,870, titled “Gas Leak Estimation” filed on Oct. 22, 2021, the entire content of which is hereby expressly incorporated by reference herein.

A first scenario prediction error is set to the difference between the calculated location of the first source and the location of the first source (from the locations of a plurality of potential sources) received at step 102. In some implementations, the above-described method of calculation of scenario prediction error can be used to calculate additional scenario prediction errors associated with other scenarios (e.g., the first source location and a second wind velocity, a second source location and the first wind velocity, a second source location and a second wind velocity, etc.). In some implementations, the first prediction error of localization associated with the first set of potential sensors is set to the largest scenario prediction error (or the scenario prediction error having the maximum value) calculated for the first set of potential sensors (e.g., for the plurality of scenarios).

The above-mentioned method of calculation of prediction error of localization can be performed for multiple sets of potential sensors (selected from the plurality of potential sensors whose locations are received at step 102). Returning back to FIG. 1, at step 106, a second prediction error of localization associated with a second set of potential sensors of the plurality of potential sensors can be calculated. The second set of potential sensors can be selected from potential sensor locations at the industrial site (e.g., the second set of locations can be selected from the regions shaded in black in the FIG. 5) and the second prediction error of localization can be calculated. This can be done, for example, by calculating a scenario prediction error for each of the plurality of scenarios (e.g., the scenarios used in the calculation of scenario prediction errors for the first set of sensors), and setting the second prediction error to a maximum value of the calculated scenario prediction errors.

In some implementations, the set of potential sensors having the smallest prediction error of localization can be selected. At step 108, the first set of potential sensors can be selected over the second set of potential sensors if the first prediction error of localization is smaller than the second prediction error of localization (e.g., when only two sets of potential sensors are selected from plurality of potential sensors whose locations are received at step 102).

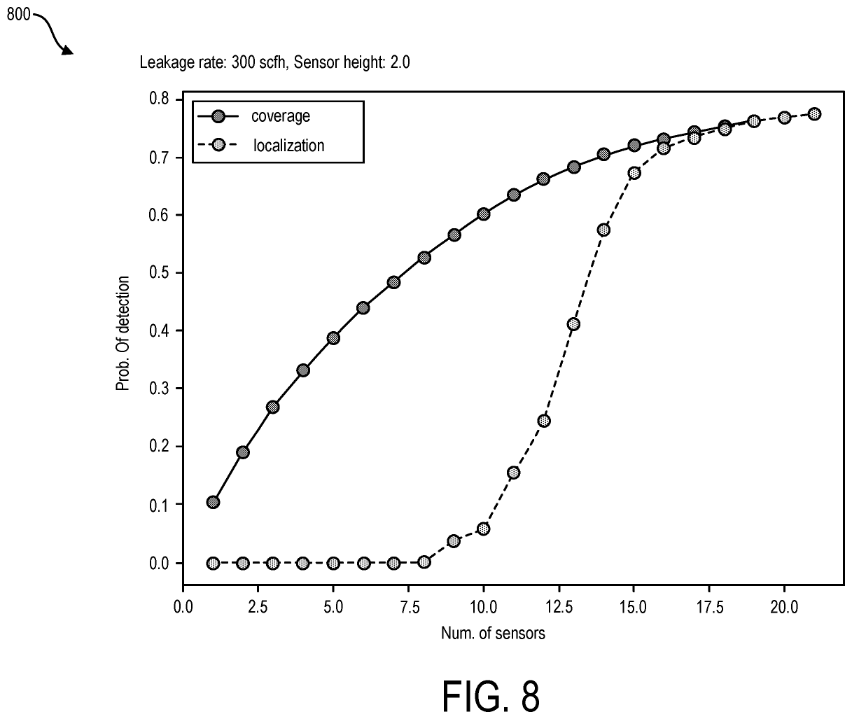

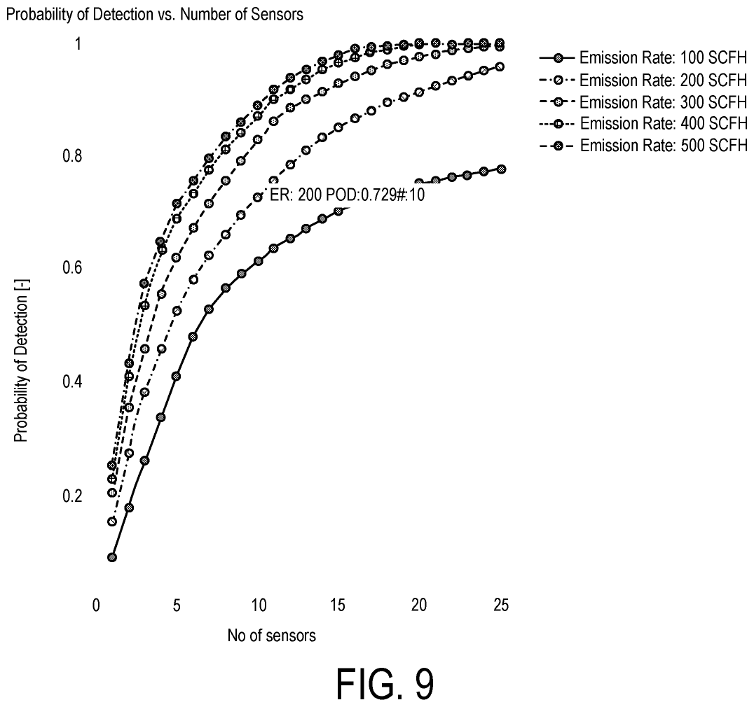

In some implementations, information associated with the set of potential sensors (e.g., location of the sensors, height of the sensors, etc.) having the smallest prediction error of localization can be provided (e.g., as described in FIG. 8 and FIG. 9). In some implementations, the computing system associated with the industrial site can provide the above-mentioned information with the set of potential sensors to an operator (e.g., via a GUI display space of the operator's computing device). For example, at step 110, locations associated the first sub-set of potential sensors (which has a smaller prediction error of localization than the second sub-set of potential sensors) can be provided.

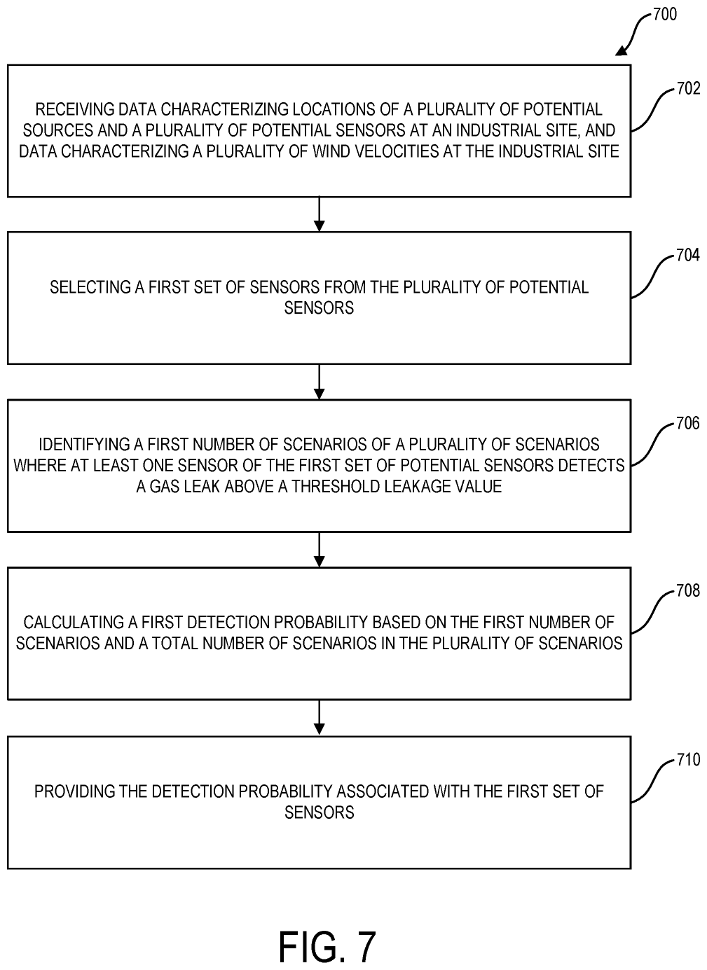

FIG. 7 is a flowchart of an exemplary method of determination of sensor locations for detection of leakage at an industrial site. At step 702, data characterizing locations of a plurality of potential sources (e.g., industrial assets, pipelines, etc.), locations of a plurality of potential sensors, and data characterizing a plurality of wind velocities (e.g., historical data on wind velocities) at an industrial site can be received (e.g., by one or more processors of a computing system associated with the industrial site). This information can be provided, for example, via a graphical user interface (GUI) display space (e.g., GUI display space 200) by a user (or an operator).

At step 704, a first set of sensors (having a first set of locations) can be selected from the plurality of potential sensors (e.g., whose locations are received at step 702). The first set of sensors can be selected such that the first set of locations are in the regions of the industrial site allocated for sensors (e.g., selected from the regions shaded in black in the FIG. 5).

At step 706, a first number of scenarios can be identified from the plurality of scenarios such that for each scenario at least one sensor of the first set of sensors detects a gas leak above a threshold leakage value. As described above, a scenario includes a wind velocity of the plurality of wind velocities and a potential source of the plurality of potential sources that are received at step 702 (or step 102). In some implementations, the determination that a sensor of the first set of sensors has detected the gas leak above the threshold value can be made using a predictive dispersion model. In some implementations, the dispersion model can be a Gaussian Plume Model (GPM) described below:

$${C}_{j} ( x , y , z ) = {\sum }_{i = 1}^{N} \frac{{S}_{i}}{2 π U {σ}_{y} ( {x}_{ij} ) {σ}_{z} ( {x}_{ij} )} ( {e}^{- \frac{{y}_{ij}^{2}}{2 {( {σ}_{y} ( {x}_{ij} ) )}^{2}}} ) [ {e}^{- \frac{{( {z}_{j} + {H}_{i} )}^{2}}{2 {( {σ}_{z} ( {x}_{ij} ) )}^{2}}} + {e}^{- \frac{{( {z}_{j} + {H}_{i} )}^{2}}{2 {( {σ}_{z} ( {x}_{ij} ) )}^{2}}} ]$$

where Cⱼ is the gas concentration detected by the j^{th} sensor, Sᵢ is the leak rate associated with the i^{th} source, U is the wind speed, and xᵢⱼ and yᵢⱼ are the distances between the i^{th} source and i^{th} sensor along the x-direction and y-direction, respectively, zⱼ is the height of the j^{th} sensor and Hᵢ is the height of the i^{th} source. The gas concentration (Cⱼ) detected by a sensor (e.g., a sensor of the first set of sensors) can be a sum of contributions from the various sources in the industrial site. The contribution of a source can be based on the leak rate (Se) of the source, the speed (U) of the wind velocity (e.g., source and wind velocity of a scenario of the first number of scenarios) and the distance between the sensor and the source along the x-coordinate, y-coordinate and z-coordinate, respectively. Only those scenarios are selected where at least one sensor of the first set of sensors detects a gas concentration (Cⱼ) greater than a threshold leakage value (C_{TH}). The threshold leakage value can be predefined and can depend on the properties of the sensors.

At step 708, a first detection probability associated with the first set of sensors can be calculated based on the first number of scenarios and a total number of scenarios in the plurality of scenarios. For example, the first detection probability can be the sum of detection probabilities of the various scenarios in the first number of scenarios. In other words, a scenario detection probability is calculated for each scenario in the first number of scenarios, the first detection probability associated with the first set of sensors can be the sum of the afore-mentioned scenario detection probabilities.

The scenario detection probability of a scenario is the product of probability of leakage in the source corresponding to the scenario and the probability of the wind velocity of the scenario. In some implementations, the probability of leakage in the source can be calculated by subject matter experts. In some implementations, in the absence of any prior knowledge, the probability of leakage of the various sources is considered to be equally likely. The probability of the wind velocity of the scenario is calculated based on historical wind velocity data.

At step 710, the first detection probability can be provided. For example, the computing system associated with the industrial site can provide the first detection probability to an operator (e.g., via a GUI display space of the operator's computing device).

Steps 702-710 can be repeated for different sets of sensors selected from the plurality of potential sensors. A detection probability can be calculated for the different sets of sensors and the set of sensors having the highest detection probability can be selected. For example, a second set of sensors from the plurality of potential sensors can be selected and a second number of scenarios can be identified from the plurality of scenarios where at least one sensor of the second set of potential sensors detects a gas leak above the threshold leakage value (e.g., determined as described above based on the predictive dispersion model). A second detection probability can be calculated based on the second number of scenarios and the second detection probability can be provided.

In some implementations, the arrangement of sensors (e.g., locations of the sensors) that is suitable (e.g., optimal) for the detection of leakage at an industrial site can be different from the arrangement of sensors that is suitable (e.g., optimal) for identification of the sources of leakage. The arrangement of sensors can vary based on the number of available sensors. The arrangement of sensors can vary based on the leak rate (Se) of the various sources at the industrial sources, sensor height, etc. FIG. 8 illustrates an exemplary graph 800 of probability of leakage source location identification (orange curve) and the probability of leak detection (blue curve) versus number of sensors. In this implementation, as the number of sensors increases, the probability of leak detection increase, and the rate of change in the increase decreases as the number of sensors increases. The probability of leakage source location identification remains unchanged (or small change) as the number of sensors increase from one sensor to about eight sensors, sharply increases above ten sensors and eventually plateaus above fifteen sensors. The graph 800 can be provided and displayed in a GUI displace space (e.g., at step 110 of FIG. 1, at step 710 of FIG. 7, etc.).

FIG. 9 illustrates an exemplary graph 900 of probability of detection versus the number of sensors for various leak rates at the industrial site. As the number of sensors increases, the probability of detection increases. The probability of detection also increases as the leak rates increases (e.g., from 100 square cubic feet per hour [SCFH] to 500 square cubic feet per hour). The graph 900 can be provided and displayed in a GUI displace space (e.g., at step 710 of FIG. 7). For example, graph 900 can be displayed on a computing device (e.g., associated with a user/operator) and can be interactive. A user can interact with the data points (represented by circular markers) in the plot (e.g., by clicking on the circular marker). The circular markers are indicative of the probability of detection for a given number of sensors and a given leakage rate. For example, when the user clicks on a marker, locations of the sensors needed to achieve the detection probability associated with the marker can be calculated (e.g., by executing steps 102-110) and information associated with the location of sensors in the industrial site can be displayed. In some implementation, a map of the industrial site with the location of the sensors can be provided.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., a GPU (graphical processing unit), an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

What is claimed is:

1. A method comprising:
receiving data characterizing locations of a plurality of potential sources and locations of a plurality of potential sensors at an industrial site, and receiving data characterizing a plurality of wind velocities at the industrial site;
calculating a first prediction error of localization associated with a first set of potential sensors of the plurality of potential sensors, the calculating based on a first set of scenario prediction errors associated with a plurality of scenarios;
calculating a second prediction error of localization associated with a second set of potential sensors of the plurality of potential sensors, the calculating based on a second set of scenario prediction errors associated with the plurality of scenarios, wherein each scenario of the plurality of scenarios comprises a wind velocity of the plurality of wind velocities and a potential source of the plurality of potential sources;
selecting the first set of potential sensors, wherein the first prediction error is lower than the second prediction error; and
providing locations associated the first sub-set of potential sensors.

2. The method of claim 1, further comprises:
calculating the first set of scenario prediction errors wherein each scenario prediction error of the first set of scenario prediction errors is associated with a unique scenario of the plurality of scenarios; and
setting the first prediction error to a maximum value of the first set of scenario prediction errors.

3. The method of claim 2, wherein a first scenario prediction error of the first set of scenario prediction errors is associated with a first scenario of the plurality of scenarios, the first scenario comprises a first source of the plurality of potential sources and a first wind velocity of the plurality of wind velocities.

4. The method of claim 3, further comprising calculating the first scenario prediction error by at least:
calculating a theoretical location of the first source using an iterative method based on a predictive dispersion model configured to receive the first wind velocity and a received location of the first source as input; and
setting the first scenario prediction error as a difference between the theoretical location and the received location of the first source.

5. The method of claim 4, wherein calculating the theoretical location is further based on a first leakage probability associated with the first source.

6. The method of claim 1, wherein each wind velocity of the plurality of wind velocities comprises a wind speed and a probability of wind flow along a direction of the wind velocity.

7. The method of claim 1, further comprising receiving a map of the industrial site, wherein the map is indicative of the locations of the plurality of potential sources and the locations of the plurality of potential sensors.

8. A method comprising:
receiving data characterizing locations of a plurality of potential sources and a plurality of potential sensors at an industrial site, and data characterizing a plurality of wind velocities at the industrial site;
selecting a first set of sensors from the plurality of potential sensors;
identifying a first number of scenarios of a plurality of scenarios where at least one sensor of the first set of potential sensors detects a gas leak above a threshold leakage value;
calculating a first detection probability associated with the first set of sensors based on the first number of scenarios and a total number of scenarios in the plurality of scenarios; and
providing the first detection probability associated with the first set of sensors.

9. The method of claim 8, wherein each scenario of the plurality of scenarios comprises a wind velocity of the plurality of wind velocities and a potential source of the plurality of potential sources.

10. The method of claim 8, wherein calculating the first detection probability comprises calculating the sum of probability of each scenario in the first number of scenarios,
wherein the probability of a first scenario in the first number of scenarios is given by the product of the probability of the first source corresponding to the first scenario and the probability of the wind velocities of the first scenario.

11. The method of claim 8, further comprising:
selecting a second set of sensors from the plurality of potential sensors;
identifying a second number of scenarios of the plurality of scenarios where at least one sensor of the second set of potential sensors detects a gas leak above the threshold leakage value;
calculating a second detection probability based on the second number of scenarios; and
providing the second detection probability associated with the second set of sensors.

12. The method of claim 11, further comprising selecting the first set of sensors over the second set of sensors, wherein the first detection probability is greater than the second detection probability, wherein the first set of sensors and the second set of sensors have an equal number of sensors.
